(19) United States
(12) Patent Application Publication
(10) Pub. No.: US 2005/0173041 A1
(43) Pub. Date: Aug. 11, 2005

(54) Pneumatic tire and method of making the same

(75) Inventor: Youjiro Miki, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd., Kobe-shi (JP)

(21) Appl. No.: 11/004,847

(22) Filed: Dec. 7, 2004

(30) Foreign Application Priority Data
Feb. 10, 2004 (JP) 2004-33898

(51) Int. Cl. B60C 13/04; B60C 13/00; B29D 30/72

(52) U.S. Cl. 152/525; 156/130.7

(57) ABSTRACT

A pneumatic tire comprises a carcass extending between bead portions through a tread portion and a pair of sidewall portions and a sidewall rubber disposed axially outside the carcass in each sidewall portion wherein the sidewall rubber is formed by a stacked-body of a rubber strip wound continuously in a tire circumferential direction, and said stacked-body comprises: an axially inner layer disposed in a side of the carcass and around which the rubber strip is wound with an overlapping width of from 30 to 90% the rubber strip width; and an axially outer layer arranged in an outer side of the inner layer so as to form an outer surface of the sidewall portion and around which the rubber strip is wound with an overlapping width being not more than 20% the rubber strip width.

### BACKGROUND OF THE INVENTION

1. Field of the Invention

The present invention relates to a pneumatic tire and method of making the same, in which a sidewall rubber is formed by a stacked-body obtained by winding a rubber strip in a tire circumferential direction, and more particularly to a pneumatic tire which can effectively prevent a sidewall rubber from being cracked.

2. Prior Art

In recent years, as shown in FIG. 7, there is proposed a pneumatic tire in which a sidewall rubber g is formed by a stacked-body b obtained by spirally winding a ribbon-shaped unvulcanized rubber strip “a” in a tire circumferential direction.

Since the sidewall rubber mentioned above can be manufactured without using a large-sized rubber extruding machine, plant and equipment can be made compact. Further, it is unnecessary to carry out an operation of replacing and adjusting a nozzle in the rubber extruding machine which has been conventionally required per the kind of the tire. This is a great advantage in recent years having a strong tendency to a large item small scale production.

However, in general, in the sidewall rubber g, a boundary of joint S between the adjacent rubber strips forms a weak point in strength after being vulcanized. Further, the boundary of joint S appears in the outer surface of the sidewall rubber g. Further, a great strain is generated on the outer surface of the sidewall rubber when a load is applied. As a result, a crack starting from an exposure point Q in which the boundary of joint S appears on the outer surface tends to be generated in the sidewall rubber g constituted by the stacked-body b.

When the crack grows along the boundary of joint S, a durability of the tire is significantly lowered. In this case, the larger the overlapping width of the adjacent rubber strips is, the more the exposure point Q is generated on the outer surface of the sidewall portion. Accordingly, the crack mentioned above is more significantly generated in such a tire.

### SUMMARY OF THE INVENTION

The present invention is made by taking the above problems into consideration, and an object of the present invention is to provide a pneumatic tire and a method of making the same which can effectively inhibit a crack from being generated on an outer surface of a sidewall portion without deteriorating an excellent productivity, by improving a structure of a stacked-body.

According one aspect of the present invention, a pneumatic tire comprises a carcass extending between bead portions through a tread portion and a pair of sidewall portions; and a sidewall rubber disposed axially outside the carcass in each sidewall portion; wherein the sidewall rubber is formed by a stacked-body of a rubber strip wound continuously in a tire circumferential direction, and said stacked-body comprises: an axially inner layer disposed in a side of the carcass and around which the rubber strip is wound with an overlapping width of from 30 to 90% the rubber strip width and an axially outer layer arranged in an outer side of the inner layer so as to form an outer surface of the sidewall portion and around which the rubber strip is wound with an overlapping width being not more than 20% the rubber strip width.

According to another aspect of the present invention, a method of making the tire comprises steps of building a green tire, and vulcanizing the green tire in a mold, the green tire comprising a carcass extending between bead portions through a tread portion and a pair of sidewall portions and a sidewall rubber disposed axially outside the carcass in each sidewall portion wherein the sidewall rubber is formed by a stacked-body of an unvulcanized rubber strip wound continuously in a tire circumferential direction, and said stacked-body comprises an axially inner layer disposed in a side of the carcass and around which the rubber strip is wound with an overlapping width of from 30 to 90% the rubber strip width and an axially outer layer arranged in an outer side of the inner layer so as to form an outer surface of the sidewall portion and around which the rubber strip is wound with an overlapping width being not more than 20% the rubber strip width.

An embodiment of the present invention will now be described in detail in conjunction with the accompanying drawings.

### BRIEF DESCRIPTION OF THE DRAWINGS

FIG. 1 is a cross sectional view showing an embodiment of a pneumatic tire in accordance with the present invention;

FIG. 2 is a cross sectional view showing a rubber strip used therein;

FIG. 3 is a cross sectional view showing a step of building a green tire;

FIG. 4 is a cross sectional view showing a green tire;

FIG. 5 is a distribution map of a tensile strain generated on an outer surface of a sidewall;

FIGS. 6A and 6B are views each showing an another embodiment of the step of building a green tire; and

FIG. 7 is a cross sectional view of a conventional pneumatic tire.

### DETAILED DESCRIPTION OF THE PREFERRED EMBODIMENTS

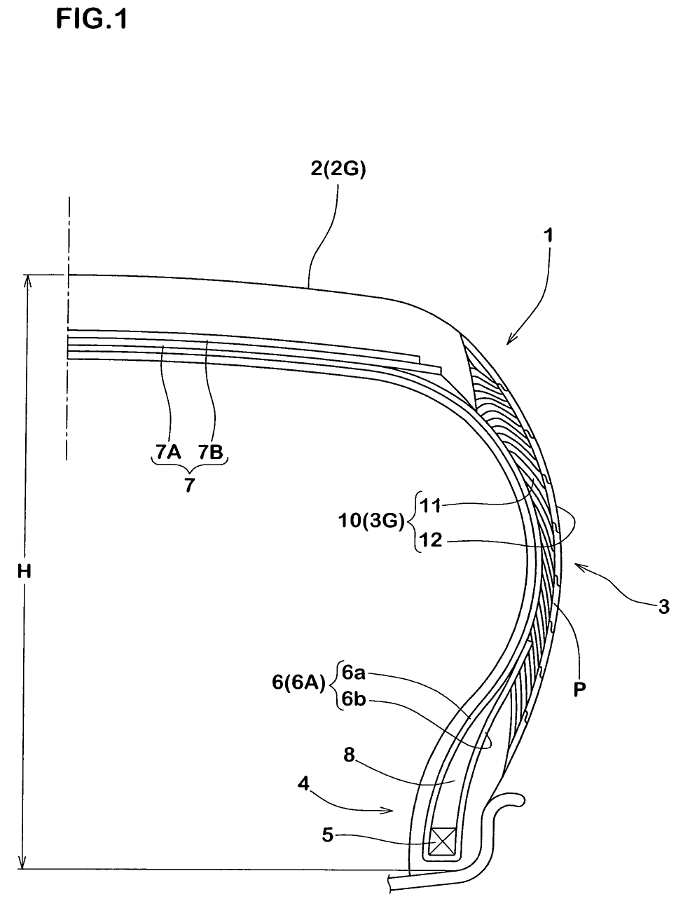

In FIG. 1, a pneumatic tire 1 according to the present invention comprises a tread portion 2, a pair of sidewall portion 3, a pair of bead portions 4 with a bead core 5 therein, a carcass 6 extending between the bead portions 4, a belt 7 disposed radially outside the carcass 6 in the tread portion 2. In this embodiment, the tire is for passenger cars, and FIG. 1 shows a cross sectional view of the tire in a standard state in which the tire is mounted on a standard rim and inflated to a standard pressure but loaded with no tire load.

Hence, the standard rim is the “standard rim” specified in JATMA, the “Measuring Rim” in ETRTO, the “Design Rim” in TRA or the like, and in case of passenger car tires, however, 180 kPa is used as the standard pressure. The standard pressure is the “maximum air pressure” in JATMA, the “Inflation Pressure” in ETRTO, the maximum pressure given in the “Tire Load Limits at Various Cold Inflation Pressures” table in TRA or the like. In case of passenger car tires, however, 180 kPa is used as the standard pressure.

Further, in the present specification, dimensions in respective portions of a tire are constituted by values specified in the standard state, as far as another other specific definition is not applied.

The carcass 6 comprises at least one ply 6A of cords arranged radially at an angle of from 70 to 90 degrees with respect to the tire equator C, and extending between the bead portions 4 through the tread portion 2 and sidewall portions 3, and turned up around the bead cores 5 from the axially inside to the axially outside of the tire so as to form a pair of turnup portions 6b and a main portion 6a therebetween. For the carcass cords, steel cords and organic fiber cords, e.g. nylon, rayon, polyester, aromatic polyamide and the like can be used depending on the use of the tire.

Each bead portion 4 is provided between the carcass ply main portion 6a and turnup portion 6b with a rubber bead apex 8 extending and tapering radially outwardly from the bead core 5.

The belt 7 comprises at least two cross plies of rubberized parallel cords which are lied at an angle of from 15 to 35 degrees with respect to the tire equator. In this example, the belt 7 is composed of a radially outer ply 7B and a radially inner ply 7A.

Further, a sidewall rubber 3G is disposed axially outside the carcass 6 in each sidewall portion 3. In the present embodiment, a radially outer edge of the sidewall rubber 3G covers an axially outer edge of a tread rubber 2G. The tire mentioned above is called as a sidewall over tread (SOT) structure. The present invention is not limited to the tire having the structure mentioned above, for example, may be constituted by a tread over sidewall (TOS) structure in which the radially outer edge of the sidewall rubber 3G is covered by the axially outer edge of the tread rubber 2G.

The sidewall rubber 3G is formed by a stacked-body 10 obtained by winding a rubber strip P continuously in a tire circumferential direction.

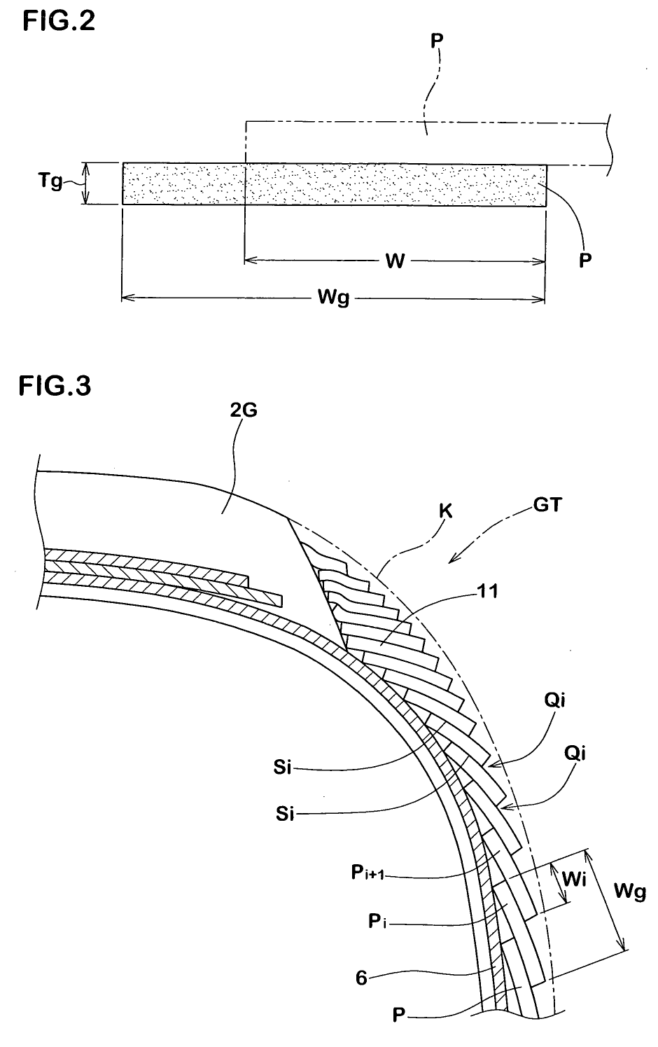

FIG. 2 shows an embodiment of a cross section of the unvulcanized rubber strip P. The rubber strip P is structured as a continuous ribbon shape.

The stacked-body 10 comprises an axially inner layer 11 disposed in a side of the carcass 6, and an axially outer layer 12 arranged in an outer side thereof and forming an outer surface 3S of the sidewall portion 3. The stacked-body 10 in accordance with the present embodiment is constituted by two layers comprising the inner layer 11 and the outer layer 12.

The method of making the pneumatic tire 1 as shown in FIG. 1 comprises steps of building a green tire GT and vulcanizing the green tire GT in a mold.

FIG. 3 shows a step of building the green tire GT in accordance with the present embodiment. In FIG. 3, the inner layer 11 is formed by directly winding the rubber strip P in an outer side of the carcass 6. In this embodiment, the unvulcanized rubber strip P is wound around the outer surface of the unvulcanized carcass 6 under a shaping state in which the carcass 6 is inflated in a toroid shape. Further, in the present embodiment, the rubber strip P is wound toward the side of the tread portion 2 from the side of the bead portion 4. Accordingly, the radially outer portion of the precedently wound rubber strip Pi is covered by the next wound rubber strip Pi+1. However, on the contrary, it is of course possible to wind the rubber strip P toward the side of the bead portion 4 from the side of the tread portion 2.

Further, in the inner layer 11, the rubber strip P is sequentially wound in the tire circumferential direction with an overlapping width Wi which is 30 to 90% of the rubber strip width Wg. The inner layer 11 forms a main portion of the stacked-body 10. Accordingly, in the present embodiment, the inner layer 11 has a comparatively larger thickness. In order to finish the stacked-body 10 in a desired finish cross sectional shape K, the inner layer 11 is finished in a cross sectional shape which is slightly smaller than the finish cross sectional shape K and is similar thereto. Further, in the inner layer 11, the rubber strip P is wound while appropriately changing the overlapping width Wi in a range of from 30 to 90% the rubber strip width Wg. Accordingly, it is possible to finish the inner layer 11 in the cross sectional shape which is similar to the various finish cross sectional shapes K. In this case, if the overlapping width Wi of the rubber strip P is less than 30% of the strip width Wg or larger than 90% thereof, there is a tendency that it is hard to obtain the desired cross sectional shape.

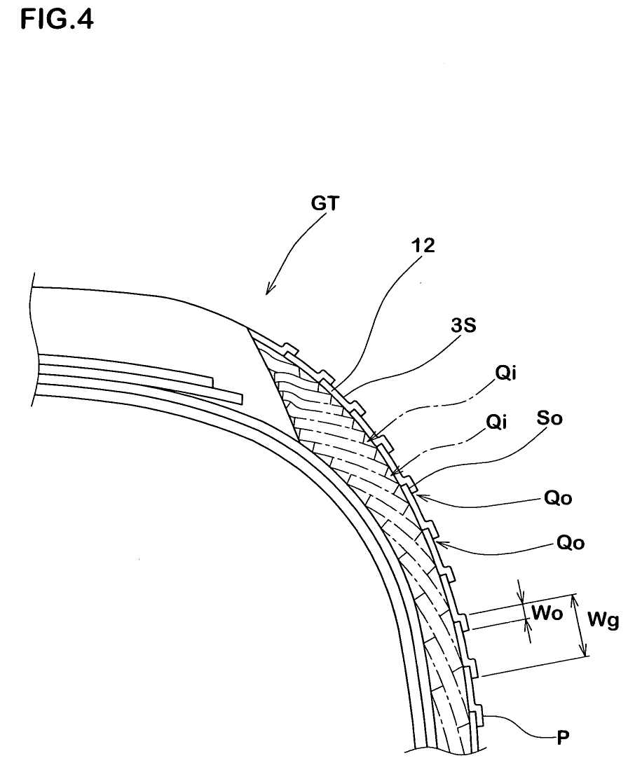

FIG. 4 shows a cross sectional view of the green tire GT, the outer layer 12 is formed by winding the rubber strip P in the outer side of the inner layer 11 in the circumferential direction of the tire. The outer layer 12 in accordance with the present embodiment is formed as a thin sheet-like coating layer. The outer layer 12 is structured, in the same manner as the inner layer 11, such that the rubber strip P is sequentially wound toward the side of the tread portion 2 from the side of the bead portion 4, however, may be inversely structured.

The rubber strip P of the outer layer 12 may be the same as the rubber strip P of the inner layer 11, or may be differentiated in the cross sectional shape, the rubber composition or the like. In the present embodiment, the rubber strip P of the outer layer 12 has substantially the same width Wg as that of the rubber strip P of the inner layer 11, however, is exemplified by the structure in which the thickness Tg is slightly smaller. In this case, the structure is not limited to this.

Further, in the outer layer 12, the rubber strip P is wound with the small overlapping width Wo which is not more than 20% of the strip width Wg. Accordingly, the outer layer 12 can cover an exposure point Qi of a boundary of joint Si of the rubber strip P formed by the inner layer 11, and can confine the exposure point Qi in the tire inner portion. Further, in the outer layer 12, the overlapping width Wo of the rubber strip P is small, the exposure point Qo of the boundary of joint So is smaller in comparison with the inner layer 11.

Hence, the strip width Wg is preferably in a range of from 5 to 50 mm, and a thickness Tg thereof is preferably in a range of from 0.5 to 3.0 mm. In the case that the width Wg is less than 5 mm, there is a tendency that a winding number for forming the stacked-body 10 is increased, and a working efficiency is deteriorated. On the contrary, in the case that the width Wg is more than 50 mm, it is hard to obtain a desired shape. Further, in the case that the thickness Tg of the rubber strip P is less than 0.5 mm, the rubber strip tends to be broken in the middle of winding, and the winding work becomes hard. On the contrary, in the case that the thickness Tg is more than 3.0 mm, a step-like great concavity and convexity is formed on the outer surface of the stacked-body 10. Since the concavity and convexity mentioned above tend to be left as a scratch after vulcanization and causes the crack, they are not preferable.

The pneumatic tire 1 is made by vulcanizing and molding the green tire GT in the mold. Therefore, in the pneumatic tire 1 in accordance with the present invention, since a lot of exposure points Qi are not formed on the surface of the sidewall rubber 3G, it is possible to effectively inhibit the crack from being generated. In the outer layer 12 of an unvulcanized state, the overlapping width Wo of the rubber strip P is preferably equal to or more than 1.0 mm, and more preferably equal to or more than 2.0 mm. In the case that the overlapping width Wo is less than 1.0 mm, there is a risk that the overlapping portions of the rubber strip P are displaced due to the stretch at the time of vulcanizing so as to be apart from each other, and this structure is not preferable.

Further, there is a tendency that the crack on the outer surface 3S of the sidewall portion is generated in accordance with an increase of the tensile strain ε in the tire radial direction generated in the outer surface 3S at the time of the tire deformation. Accordingly, in the present embodiment, the overlapping width Wo of the outer layer 12 is not more than 10% of the strip width Wg in a large-strain region Yε of the sidewall portion 3.

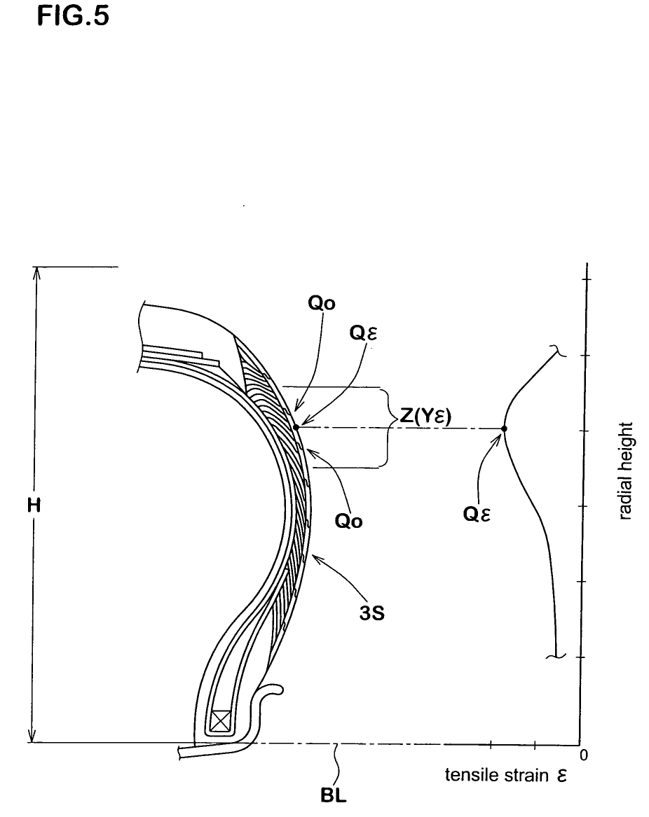

Hence, the large-strain region Yε is a circumferential region including a maximum strain position Qε as a center line thereof and having a width Z which is 20% of a tire height H (shown in FIG. 1). The maximum strain position Qε as shown in FIG. 5 is a position in which the tensile strain ε in the tire radial direction generated on the outer surface 3S of the sidewall portion is a maximum in a standard load applying state. Further, the standard load applying state is a state that the tire is mounted on the standard rim and inflated by the standard pressure and loaded with a standard load. The standard load is the “maximum load capacity” in JATMA, 88% of the “Load Capacity” in ETRTO, the maximum value given in the above-mentioned table in TRA or the like.

FIG. 5 shows a relation between above tensile strain ε in the standard load applying state and a radial height from the bead base line BL. As is apparent from the drawing, the maximum strain position Qε is positioned near a buttress portion. Further, the tensile strain εis comparatively largely generated in the large-strain region YE around the maximum strain position Qε. Accordingly, it is possible to further reduce the exposure point Qo by making the overlapping width Wo of the rubber strip P of the outer layer 12 smaller to be equal to or less than 10% of the rubber strip width Wg, in the region Yε, and it is possible to inhibit the crack more effectively.

Further, for the same reason as mentioned above, it is possible to effectively inhibit the crack by displacing the position of the boundary of joint So of the rubber strip P in the outer layer 12 in the tire radial direction from the maximum strain position Qε.

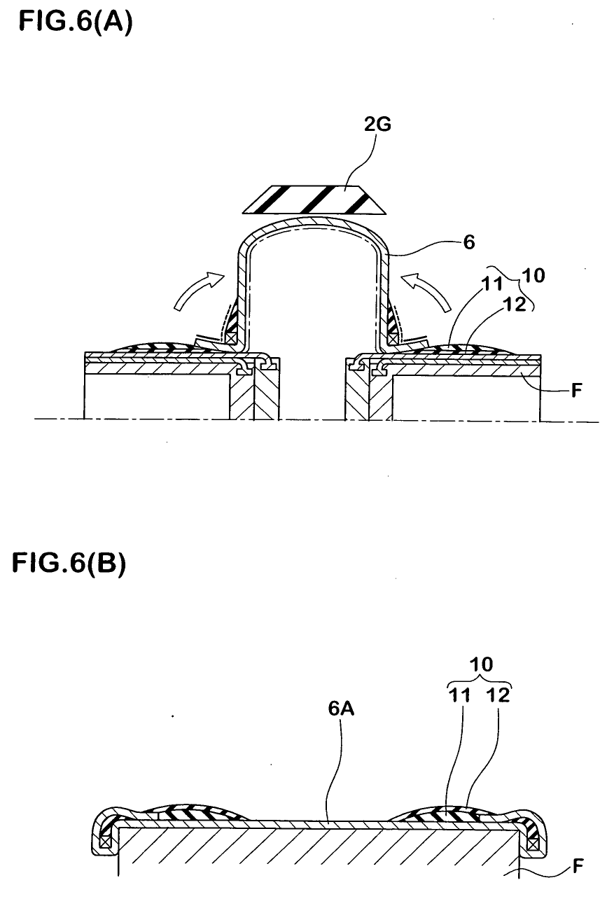

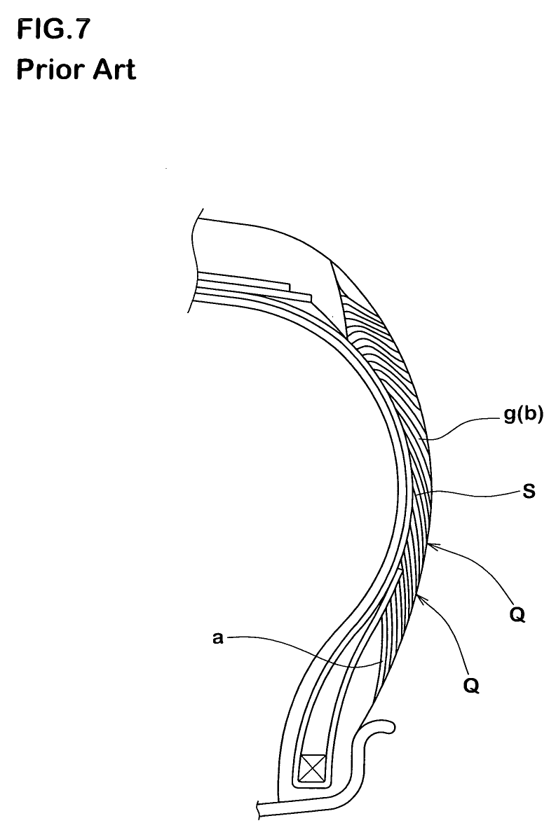

Further, in the case that the tire 1 has the SOT structure mentioned above, for example, as shown in FIG. 6A, the stacked-body 10 of the green tire may be formed by winding the rubber strip on a cylindrical former F. In this case, the outer layer 12 is first wound around an outer side of the former F, and thereafter, the inner layer 11 is wound around an outer side thereof. Further, the stacked-body 10 can be adhered in an inverted state to the side portion of the shaping state carcass 6 to which the tread rubber 2G has been adhered.

Further, in the case that the tire has the TOS structure, for example, as shown in FIG. 6B, the stacked-body 10 of the green tire may be formed by first winding the inner layer 11 around the outer side of the side portion of the cylindrical carcass ply 6A wound on the former F, and next winding the outer layer 12 sequentially, and thereafter the carcass ply 6A is shaped in the toroid shape and the tread rubber 2G is adhered thereto.

The description has been given in detail of the particularly preferable embodiments in accordance with the present invention, however, the present invention is not limited to the illustrated embodiments, and can be achieved by variously modifying.

Comparison Tests

A crack resistance is estimated with respect to tires (size 195/55R15) manufactured by way of trial on the basis of the specification in Table 1. The overlapping widths Wi and Wo are shown as average values by measuring the overlapping widths of the respective rubber strips in respective transverse sections in four positions in the tire circumferential direction of the finished tire.

Further, the crack resistance is estimated by leaving the tire within the oven in a dry state at 80° C. for twelve days, executing a drum test running at a speed of 50 km/h under a condition of an internal pressure (220 kPa) and a load (150% load of the standard load), and measuring a running time until the crack is generated in the outer surface of the sidewall. The estimation is displayed by an index obtained by setting Comparative Example 1 to 100. The larger the numerical value is, the better the crack resistance is.

The results of the test and the like are shown in Table 1, and it can be confirmed that the crack resistance in the tires of Examples is greatly improved.

TABLE 1

| | Comparative | | | | | Comparative | Comparative |
|---|---|---|---|---|---|---|---|
| | Example 1 | Example 1 | Example 2 | Example 3 | Example 4 | Example 2 | Example 3 |
| Sidewall rubber | Stacked-body | Stacked- | Stacked- | Stacked- | Stacked- | Stacked-body | Stacked-body |
| | | body | body | body | body | | |
| Rubber strip | | | | | | | |
| Width Wg [mm] | 20 | 20 | 20 | 20 | 20 | 20 | 20 |
| Thickness Tg [mm] | 1.0 | 1.0 | 1.0 | 1.0 | 1.0 | 1.0 | 1.0 |
| Inner layer | | | | | | | |
| Overlapping width | 81 | 81 | 81 | 81 | 81 | 81 | 81 |
| Wi [%] | | | | | | | |
| Outer layer | | | | | | | |
| Overlapping width | 81 | 11 | 19 | 6 | 0.5 | 32 | 48 |
| Wo [%] | | | | | | | |
| Crack resistance | 100 | 139 | 126 | 154 | 167 | 108 | 105 |

*) Overlapping widths Wi and Wo are rate with respect to rubber strip width Wg

1. A pneumatic tire comprising:
a carcass extending between bead portions through a tread portion and a pair of sidewall portions; and
a sidewall rubber disposed axially outside the carcass in each sidewall portion; wherein
the sidewall rubber is formed by a stacked-body of a rubber strip wound continuously in a tire circumferential direction, and
said stacked-body comprises:
an axially inner layer disposed in a side of the carcass and around which the rubber strip is wound with an overlapping width of from 30 to 90% the rubber strip width; and
an axially outer layer arranged in an outer side of the inner layer so as to form an outer surface of the sidewall portion and around which the rubber strip is wound with an overlapping width being not more than 20% the rubber strip width.

2. A pneumatic tire according to claim 1, wherein
the rubber strip width is in a range of from 5 to 50 mm.

3. A pneumatic tire according to claim 1, wherein
the rubber strip has a thickness of from 0.5 to 3.0 mm.

4. A pneumatic tire according to claim 1, wherein
a maximum strain position in which a tensile strain ε in a tire radial direction generated in the outer surface of the sidewall portion is maximum in a standard load applying state exists at the other position than a boundary of joint between the adjacent rubber strips in the outer layer.

5. A pneumatic tire according to claim 1, wherein
the overlapping width of the rubber strip in the outer layer is not more than 10% the rubber strip width in a large-strain region,
wherein the large-strain region is a circumferential region including a maximum strain position as a center line thereof and having a width which is 20% of a tire height H, and
the maximum strain position is a position in which a tensile strain ε in a tire radial direction generated in the outer surface of the sidewall portion is maximum in a standard load applying state.

6. A method of making a pneumatic tire, wherein the method comprises steps of
building a green tire, and
vulcanizing the green tire in a mold,
the green tire comprising:
a carcass extending between bead portions through a tread portion and a pair of sidewall portions; and
a sidewall rubber disposed axially outside the carcass in each sidewall portion; wherein
the sidewall rubber is formed by a stacked-body of an unvulcanized rubber strip wound continuously in a tire circumferential direction, and
said stacked-body comprises:
an axially inner layer disposed in a side of the carcass and around which the rubber strip is wound with an overlapping width of from 30 to 90% the rubber strip width; and
an axially outer layer arranged in an outer side of the inner layer so as to form an outer surface of the sidewall portion and around which the rubber strip is wound with an overlapping width being not more than 20% the rubber strip width.

7. A method of making a pneumatic tire according to claim 6, wherein the rubber strip width is in a range of from 5 to 50 mm.

8. A method of making a pneumatic tire according to claim 6 or 7, wherein the rubber strip has a thickness of from 0.5 to 3.0 mm.
